(19) United States
(12) Patent Application Publication
(10) Pub. No.: US 2007/0159668 A1
(43) Pub. Date: Jul. 12, 2007

(54) IMAGE PROCESSING DEVICE AND IMAGE PROCESSING METHOD THEREOF

(75) Inventor: Kui-Lv, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/622,127

(22) Filed: Jan. 11, 2007

(30) Foreign Application Priority Data
Jan. 11, 2006 (TW) 95101089

(51) Int. Cl. H04N 1/40

(52) U.S. Cl. 358/484; 358/3.01

(57) ABSTRACT

An image processing device and an image processing method thereof are provided. The image processing device includes an optical module and a processing unit. The optical module includes several original light sources and a sensing unit. The image processing method includes the following steps. Firstly, a target color is set. Next, in a retrieving process, several original lights are projected on an article according to the target color, and the total quantities of the original lights are controlled to form several corresponding optical signals. After that, the optical signals are sensed to generate several electric signals. Lastly, a target gray-scale image data is obtained according to the electric signals.

This application claims the benefit of Taiwan application Serial No. 095101089, filed Jan. 11, 2006, the subject matter of which is incorporated herein by reference.

### BACKGROUND OF THE INVENTION

1. Field of the Invention

The invention relates in general to an image processing device and an image processing method thereof, and more particularly to an image processing device controls the total quantity of the original lights to obtain a target gray-scale image data according to a target color and an image processing method.

2. Description of the Related Art

With the rapid advance in color image processing technology and color image processing device, a color image processing device can apply image processing such as enlargement/reduction, coloring, clipping, luminance or contrast adjustment to make an image more versatile. Moreover, image processing can be carried out by an ordinary computer, making the application of color processing device and relevant software even more popular.

In the color image processing method, the gray-scale image data, having the advantage of using only requires a small amount of data volume, is widely applied in the color image processing technology.

When applying the grey level information, some colors in the patterns of the original color image have to be filtered or enhanced. However, the conventional color image processing method is normally unable to process the colors flexibly, and often a subsequent manual process is required. For example, an image editing software is used to remove or enhance a particular color before converting the image added by the translator into grey level information, not only reducing the efficiency of image processing but also deteriorating the image quality.

### SUMMARY OF THE INVENTION

It is therefore an object of the invention to provide an image processing device and an image processing method thereof. The total quantities of the original light are controlled according to a target color to obtain a target gray-scale image data. The target gray-scale image data is capable of truthfully representing the target color intensity of each pixel of an article and flexibly performing makes color processing according to user needs, not only enhancing the efficiency of image processing but also improving image quality.

The invention achieves the above-identified object by providing an image processing device. The image processing device includes an optical module and a processing unit. The optical module includes several original light sources and a sensing unit. The original light sources are for projecting several original lights on an article to form corresponding optical signals in a retrieving process. The sensing unit is for sensing the optical signals to generate several electric signals. The processing unit is for controlling the total quantities of the original lights emitted by the original light sources according to a target color in an image retrieving process, and obtaining a target gray-scale image data according to the electric signals.

The invention achieves another object by providing an image processing device. The image processing device includes an optical module and a processing unit. The optical module includes several original light sources and a sensing unit. The original light sources are used for projecting several original lights on an article in a retrieving process to form corresponding optical signals. The sensing unit is for sensing the optical signals to generate several electric signals. The processing unit controls the total quantities of the original lights emitted by the original light sources according to a target color in an image retrieving process, generates several original color gray-scale image data corresponding to the original colors according to the electric signals, and merges the original color gray-scale image data to obtain a target gray-scale image data according to a combination ratio. There is an illuminating ratio existing among the total quantities of the original lights. The overall ratio formed by the combination ratio and the illuminating ratio corresponds to the luminance ratio of the original lights required for forming the target color. When the total quantities of the original lights are the same, the combination ratio corresponds to the luminance ratio of the original lights required for forming the target color.

The invention achieves another object by providing an image processing method. Firstly, a target color is obtained. Next, several original lights are projected on an article according to the target color in a retrieving process and the total quantities of the original lights are controlled to form several corresponding optical signals. After that, the optical signals are sensed to generate several electric signals. Next, a target gray-scale image data is obtained according to the electric signals.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of an image processing device according to the invention;

FIG. 2 is flowchart of an image processing method according to the invention;

FIG. 3A is a time-varying diagram of a red light source luminance according to a first embodiment of the invention;

FIG. 3B is a time-varying diagram of a green light source luminance according to a first embodiment of the invention;

FIG. 3C is a time-varying diagram of a blue light source luminance according to a first embodiment of the invention;

FIG. 4A is a time-varying diagram of a red light source luminance according to a second embodiment of the invention;

FIG. 4B is a time-varying diagram of a green light source luminance according to a second embodiment of the invention;

FIG. 4C is a time-varying diagram of a blue light source luminance according to a second embodiment of the invention;

FIG. 5A is a time-varying diagram of a red light source luminance according to a third embodiment of the invention,

FIG. 5B is a time-varying diagram of a green light source luminance according to a third embodiment of the invention;

FIG. 5C is a time-varying diagram of a blue light source luminance according to a third embodiment of the invention;

FIG. 6A is a time-varying diagram of a red light source luminance according to a fourth embodiment of the invention;

FIG. 6B is a time-varying diagram of a green light source luminance according to a fourth embodiment of the invention; and

FIG. 6C is a time-varying diagram of a blue light source luminance according to a fourth embodiment of the invention.

### DETAILED DESCRIPTION OF THE INVENTION

### FIRST EMBODIMENT

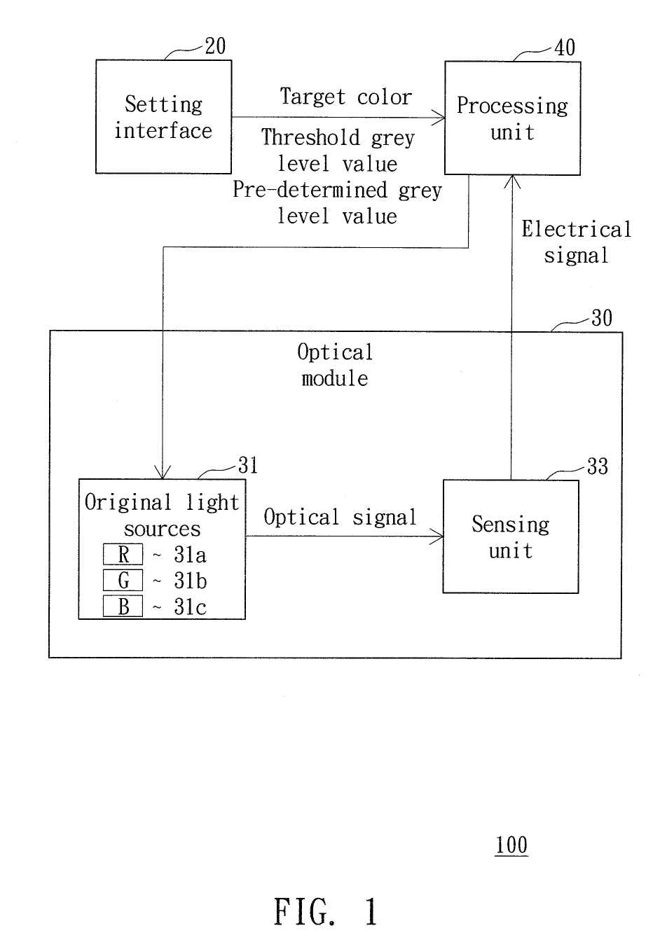

Referring to FIG. 1, a diagram of an image processing device according to the invention is shown. The image processing device 100 is exemplified by a scanner or a multi-functional machine for applying image processing to an article. The image processing device 100 includes an optical module 30, a processing unit 40 and a setting interface 20.

The setting interface 20 is for setting a target color, and examples of the setting interface 20 include an external universal device (not illustrated) independently disposed outside the image processing device 100. The image processing device 100 can further include a connecting port (not illustrated) for connecting the external universal device. Examples of the external universal device include a computer, and examples of the connecting port include a universal serial bus (USB) port. The target color can be pre-set in the processing unit 40 or via the external universal device, and the target color does not have to be set by the setting interface 20.

The optical module 30 includes several original light sources 31 and a sensing unit 33. The sensing unit 33 is for sensing and converting an optical signal into an electric signal. The processing unit 40 converts the electric signal into a target gray-scale image data. Then, the processing unit 40 can further process the target gray-scale image data or outputs an image corresponding to the above article.

The processing unit 40 controls the projection time or luminance of the original light sources 31 according to the target color, and the present embodiment of the invention is exemplified by controlling the projection time of the original light sources 31. The original light sources 31 include a red light emitting diode (LED) 31a, a green LED 31b and a blue LED 31c. Examples of the article include a reflective article and a transmissive article. After the original light sources 31 are projected onto the reflective article or the transmissive article, the original light sources 31 respectively reflect or transmit several optical signals. In the present embodiment of the invention, the article is exemplified by a reflective article. The sensing unit 33 senses and converts the optical signals reflected by the article into several electric signals. Examples of the sensing unit 33 include a contact image sensor (CIS).

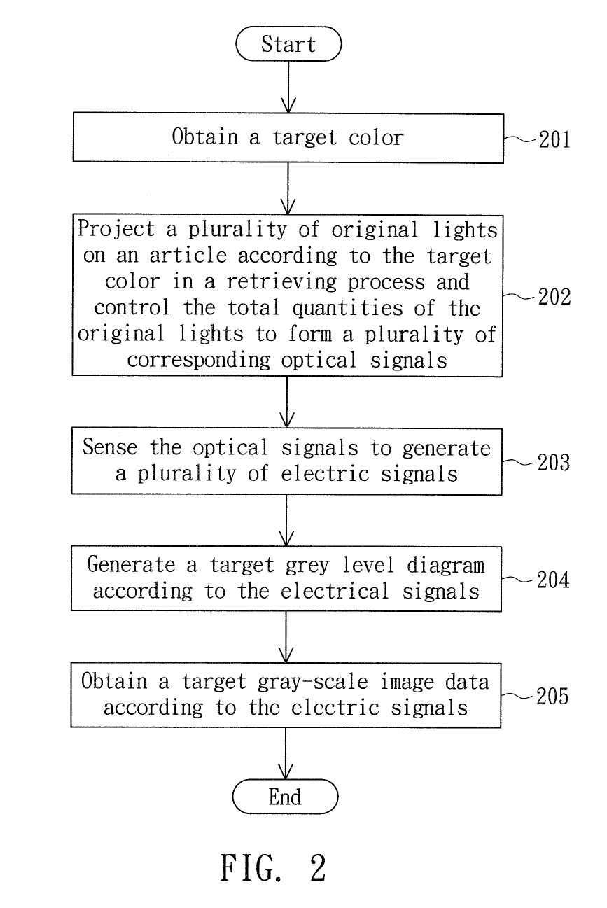

Referring to both FIG. 1 and FIG. 2. FIG. 2 is a flowchart of an image processing method according to the invention. For the convenience of elaboration, the method is exemplified by weakening a target color of a reflective article. Firstly, the image processing method begins at step 201, a target color is set by a user via a setting interface 20. The target color is exemplified by orange color whose grey level combination reads as: red, 255; green, 204; and blue, 51. Normally, a color image is denoted by a number of original colors with different grey level intensities, as indicated in the denotation of the orange color. The gray-scale image data can be denoted by a single grey level value such as 123. In the present embodiment of the invention, various colors are composed of the three original RGB colors whose grey level values range between 0-255, wherein 0 denotes the minimum luminance and 255 denotes the maximum luminance. The above denotation of color is simply a man-made definition, so the opposite logical setting, the change in the range of level and other logical or formal changes are all permissible. Next, the RGB LEDs 31a, 31b and 31c of the original light sources 31 are controlled by the processing unit 40 of the optical module 30 according to the set orange color (255, 204, 51) and are projected onto the article, as indicated in step 202. After that, the optical signals reflected by the article are sensed and converted into several electric signals, and outputted by the sensing unit 33. The orange block of the article has stronger reflection against orange light than other color blocks, therefore, of the electric signals outputted by the sensing unit, so the difference between the orange block and the background color (white color for example) is reduced, and the orange pattern is weakened, as indicated in step 203. Next, a target gray-scale image data is generated by the processing unit 40 according to the electric signals, as indicated in step 204.

Besides, the processing unit 40 further receives a target color set by the setting interface 20, and analyzes the original light sources required for forming a luminance ratio of the target color according to the target color. For example, the target color set by the setting interface 20 is orange color (255, 204, 51), and the processing unit 40 analyzes that the luminance ratio required for the three original RGB colors to form the orange color is read as 5:4:1. However, the luminance ratio can be denoted by 255:204:51 or other ratio scales. Or, if the setting interface is an external universal device independently disposed outside the image processing device, the setting interface can transmit the luminance ratio of the original lights required for forming the target color to the processing unit 40 via the connecting port.

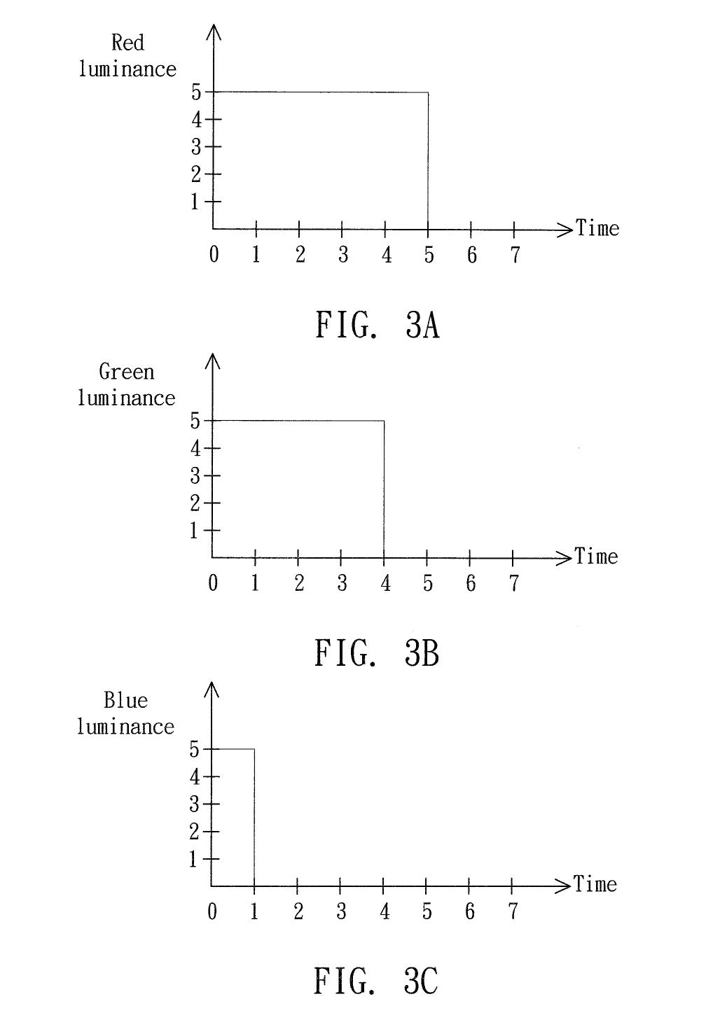

Referring to FIG. 3A˜FIG. 3C at the same time. The respective time-varying diagrams of the RGB light source luminance according to a first embodiment of the invention are shown. In the present embodiment of the invention, the processing unit 40 controls the illuminating duration of the original light sources according to an illuminating ratio. The illuminating ratio corresponds to the luminance ratio of each of the original lights required for forming the target color. The illuminating ratio can be equal to, enlarge/reduce or be complementary to the luminance ratio of the original lights required for forming the target color. The step of controlling the original light sources 31 includes the following sub-steps. Firstly, the processing unit 40 controls the original light sources 31 at time point 0 and turns on the red, the green and the blue LEDs 31a, 31b and 31c at the same time. Next, the processing unit 40 sequentially turns off the blue, the green and the red LEDs 31a, 31b and 31c according to an illuminating ratio such as 5:4:1. As indicated in FIG. 3A˜FIG 3C, the processing unit 40 turns off the blue LED 31c at time point 1, turns off the green LED 31b at time point 4, and turns off the red LED 31a at time point 5. Thus, the sensing unit 33 can obtain the mixed optical signals, equal to a simulated orange color (255, 204, 51) light source, reflected by the article. The processing unit 40 can weaken the orange color according to the orange gray-scale image data obtained by the mixed optical signals. The sensing unit 33 has several pixels, and the gray-scale image data includes several pixel grey level values corresponding to the pixels.

Moreover, the user can further process the target gray-scale image data according to the following steps. Firstly, a threshold range is set. Next, a determination is made as to whether an individual pixel grey level value falls within the threshold range. After that, the individual pixel grey level value of the pixel falling within the threshold range is converted into a pre-determined grey level value. The present embodiment of the invention is further exemplified by the process of filtering the orange color (255, 204, 51). For example, if the grey level range is assumed to range between 0-255 and the pixel grey level value of the gray-scale image data corresponds to the orange block on an article is 210, the user can set a threshold grey level value (such as 200) and a pre-determined grey level value (such as the maximum grey level value 255 of the target color), wherein the threshold range is set as the range larger than the threshold grey level value. Next, the processing unit 40 converts the individual pixel grey level value that is larger than 200 to 255, such that the orange color (255, 204, 51) is filtered. The threshold grey level value and the pre-determined grey level value can be set in the setting interface 20 or directly stored in the processing unit 40.

The present embodiment of the invention is exemplified by weakening a target color. However, if the object is to enhance the target color, the ratio complementary to the luminance ratio used in the analysis of the target color can be used as the illuminating ratio of the original light sources. For example, the ratio of 0:1:4 complementary to the luminance ratio of the orange color (255, 204, 51) is used as the illuminating ratio of the original light sources. As for which of the above two ways is adopted depends on whether the target color of the article is to be enhanced or weakened. Besides, the selection of weakening or enhancing the target color can be set in the setting interface 20 or directly stored in the processing unit 40.

The article of the present embodiment of the invention is exemplified by a reflective article. However, if the article is a transmissive article, the logical transformation in the process of weakening or enhancing the target color is adjusted according to whether the pattern is positive or negative. Such logical transformation can be set in the setting interface 20 or directly stored in the system.

The gray-scale image data obtained by the image processing device 100 can be stored as a document in an in-built memory, or directly outputted. For example, the image can be outputted to an in-built display interface or an in-built printer, or the image can be outputted to an external universal device via a connecting port. Examples of the external universal device including a computer, a printer or an image outputting devices are still within the scope of the technology of the invention.

### SECOND EMBODIMENT

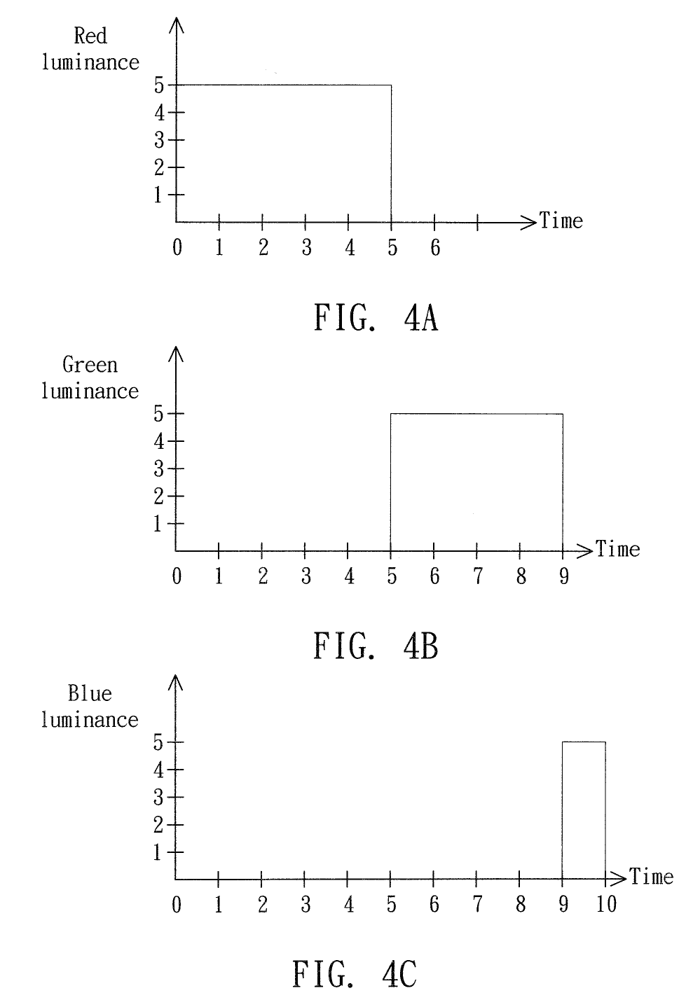

The image processing method of the present embodiment of the invention differs with the image processing method of the first embodiment in the step of controlling the original light sources 31. As for the similarities, the same reference numbers are used and are not repeated here. Referring to FIG. 4A˜FIG 4C at the same time. The respective time-varying diagrams of the RGB light source luminance according to second embodiment are shown. In the step of controlling the original light sources, the processing unit 40 sequentially controls the RGB LEDs 31a, 31b and 31c to illuminate according to the illuminating duration of the illuminating ratio of the first embodiment. As indicated in FIG. 4A˜FIG. 4C, the processing unit 40 turns on the red LED 31a at time point 0, but turns off the red LED 31a at time point 5. The processing unit 40 turns on the green LED 31 b at time point 5, but turns off the green LED 31b at time point 9. The processing unit 40 turns on the blue LED 31c at time point 9, but turns off the blue LED 31c at time point 10. Thus, the sensing unit 33 can obtain the mixed optical signals, equal to a simulated orange color (255, 204, 51) light source, reflected by the article. The processing unit 40 can weaken the orange color according to the orange gray-scale image data obtained by the mixed optical signals. According to the second embodiment, the original light sources do not illuminate at the same time, and the instantaneous current can be lower.

### THIRD EMBODIMENT

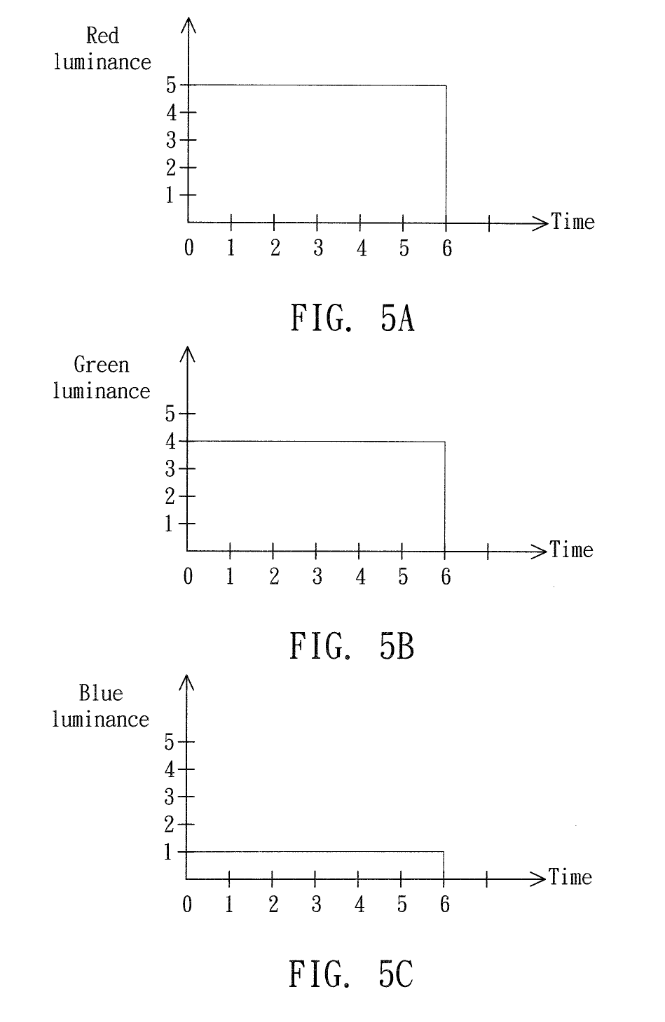

The image processing method of the present embodiment of the invention differs with the image processing method of the first embodiment in the step of controlling the original light sources. As for the similarities, the same reference numbers are used and are not repeated here. Referring to FIG. 5A˜FIG. 5C at the same time. The respective time-varying diagrams of the RGB light source luminance according to the third embodiment are shown. Firstly, three resistors corresponding to the RGB LEDs 31a, 31b and 31c are provided in the optical module 30. Next, the processing unit 40 controls the currents flowing through the RGB LEDs 31a, 31b and 31c to be at a ratio of 5:4:1 by the three resistors. The processing unit 40 controls the currents flowing three original LEDs 31a, 31b and 31c by applying various voltage levels or employing variable resistors to produce various resistances. As indicated in FIG. 5A˜FIG. 5C, the three original LEDs 31a, 31b and 31c are all turned on at time point 0, but turned off at time point 6. The ratio of the luminance emitted by the three original LEDs 31a, 31b and 31c when driven by currents is 5:4:1. Thus, the sensing unit 33 can obtain the mixed optical signals, equal to a simulated orange color (255, 204, 51) light source, reflected by the article. The processing unit 40 can weaken the orange color according to the orange gray-scale image data obtained by the mixed optical signals. The method disclosed in the third embodiment of the invention requires shorter scanning time than the method disclosed in the above embodiment does.

Different ways of controlling the original light sources according to illuminating time, illuminating sequence and luminance are disclosed in the above embodiments. However, a combination of the controlling methods disclosed above is applicable. For example, the light source can be controlled according to illuminating time and luminance, and the light sources of the first embodiment can be sequentially illuminated and the light can be partly overlapped. Similar combinations can be many. Any image retrieving process whose illuminating ratio of the total quantities of the original lights source corresponds to the luminance ratio of the target color is within the scope of the technology of the invention.

### FOURTH EMBODIMENT

The image processing method of the present embodiment of the invention differs with the image processing method of the first embodiment in the step of controlling the original light sources. As for the similarities, the same reference numbers are used and are not repeated here. Referring to

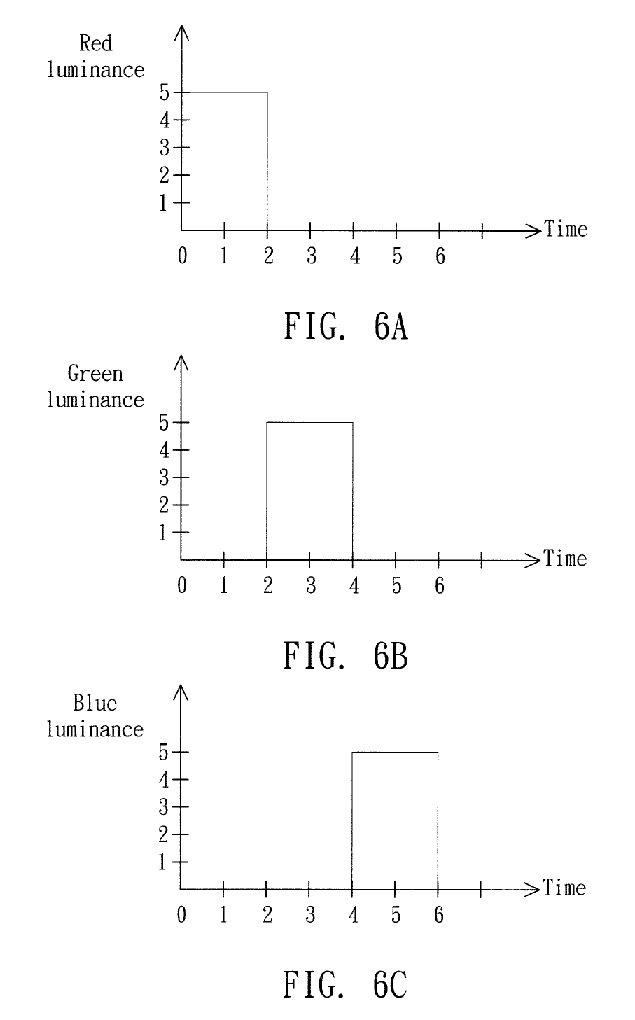

FIG. 6A˜FIG. 6C at same time. The respective time-varying diagrams of the RGB light source luminance according to fourth embodiment are shown. In the step of controlling the original light sources, the processing unit 40 sequentially controls the RGB LEDs 31a, 31b and 31c to illuminate with the same illuminating duration and the same luminance. As indicated in FIG. 6A˜FIG. 6C, the processing unit 40 turns on the red LED 31a at time point 0, but turns off the red LED 31 a at time point 2. The processing unit 32 turns on the green LED 31 b at time point 2, but turns off the green LED 31 b at time point 4. The processing unit 40 turns on the blue LED 31c at time point 4, but turns off the blue LED 31c at time point 6. Thus, the optical module 30 receives the optical signals of the three original colors respectively.

In the fourth embodiment, the step of generating a target gray-scale image data includes the following sub-steps. Firstly, after the sensing unit 33 senses the three optical signals to generate three electric signals respectively, and the processing unit 40 respectively generates an RGB original color gray-scale image data corresponding to the three original colors. Next, the processing unit 40 composes an orange color (255, 204, 51) gray-scale image data according to a combination ratio of 5:4:1 of the three original color gray-scale image data. The combination ratio corresponds to the luminance ratio of the original lights required for forming the target color. The combination ratio can be equal to, enlarge/reduce or be complementary to the luminance ratio of the original lights required for forming the target color, such that the pattern of the orange color (255, 204, 51) can be weakened or enhanced.

In the fourth embodiment, the processing unit 40 can control the illuminating ratio among the total quantities of the RGB LEDs 31a, 31b and 31c to be 2.5:2:1 for instance. After the sensing unit 33 senses three optical signals to generate three electric signals respectively, the processing unit 40 respectively generates an RGB original color gray-scale image data corresponding to the three original colors. Next, the processing unit 40 composes an orange color (255, 204, 51) gray-scale image data according to a combination ratio of 2:2:1 of the three original color gray-scale image data. The overall ratio formed by the combination ratio 2:2:1 and the combination ratio of 2.5:2:1 of the total quantities of the original lights is 2×2.5:2×2:1×1 (equals to 5:4:1). That is, the overall ratio corresponds to the luminance ratio of the original lights required for forming the target color. This method reduces the difference between the maximum total quantity and the minimum total quantity of the original light sources, makes the control of the total quantity of the original light sources easier, and further reduces the scanning time.

Despite the image processing method is exemplified by an image retrieving period in the above four embodiments, however, the method is also applicable to the image processing with more than one image retrieving period. The image processing method of the invention is also applicable to a dynamic article, and obtains a dynamic image by retrieving several frames of continuous images.

Despite the image processing method is exemplified by weakening the orange color in the above four embodiments, however, the invention is also applicable to the image processing such as to enhance or replace a certain color or convert a chromatic image to a mono-chromatic image. Any image processing achieving the target gray-scale image data by controlling several original light sources according to the determined target color are within the scope of the technology of the invention.

Despite the original light sources are exemplified by the RGB LEDs in the above four embodiments, however, the invention is also applicable to six-colored, eight-colored or multi-colored light sources. Any image processing achieving the target gray-scale image data by controlling several original light sources according to the determined target color are within the scope of the technology of the invention.

According to the image processing device and the image processing method disclosed in the above embodiments of the invention, the target gray-scale image data is achieved by controlling several original light sources according to the determined target color. The target gray-scale image data not only truly presents the target color intensity of each pixel of the article, but makes color processing further flexible according to user needs. Consequently, both the image processing efficiency and the image quality are improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing device, comprising:
an optical module, comprising:
a plurality of original light sources for projecting a plurality of original lights on an article in a retrieving process to form a plurality of corresponding optical signals; and
a sensing unit for sensing the optical signals to generate a plurality of electric signals; and
a processing unit for controlling the total quantities of the original lights emitted by the original light sources in the image retrieving process according to a target color, and obtaining a target gray-scale image data according to the electric signals.

2. The image processing device according to claim 1, wherein the processing unit controls the projection time of each of the original light sources in the retrieving process, such that an illuminating ratio exists among the total quantities of the original lights, and the illuminating ratio corresponds to the luminance ratio of the original lights required for forming the target color.

3. The image processing device according to claim 1, wherein the processing unit controls the luminance of each of the original lights source in the retrieving process, such that an illuminating ratio exists among the total quantities of the original lights, and the illuminating ratio corresponds to the luminance ratio of the original lights required for forming the target color.

4. The image processing device according to claim 1, wherein the sensing unit has a plurality of pixels, and the gray-scale image data comprises a plurality of pixel grey level values corresponding to the pixels;
if the pixel grey level value of one of the pixels falls within a threshold range, then the processing unit converts the pixel grey level value of the pixel into a pre-determined grey level value.

5. The image processing device according to claim 4, wherein the threshold range is the range larger than a threshold grey level value, and the pre-determined grey level value is the maximum grey level value of the target color.

6. The image processing device according to claim 5, further comprising:
a setting interface for setting the threshold grey level value and the pre-determined grey level value.

7. The image processing device according to claim 1, further comprising:
a setting interface for setting the target color.

8. The image processing device according to claim 1, further comprising:
an image outputting device for outputting an image according to the target gray-scale image data.

9. The image processing device according to claim 1, further comprising a connecting port, wherein the connecting port is for connecting a setting interface, and the setting interface is for setting the target color.

10. An image processing device, comprising:
an optical module, comprising:
a plurality of original light sources for projecting a plurality of original lights on an article in a retrieving process to form a plurality of corresponding optical signals; and
a sensing unit for sensing the optical signals to generate a plurality of electric signals; and
a processing unit for controlling the total quantities of the original lights emitted by the original light sources in the image retrieving process according to a target color, generating a plurality of original color gray-scale image data corresponding to the original colors according to the electric signals, and merging the original color gray-scale image data according to a combination ratio to obtain a target gray-scale image data, wherein an illuminating ratio exists among the total quantities of the original lights, and an overall ratio formed by the combination ratio and each of the illuminating ratios corresponds to the luminance ratio of the original lights required for forming the target color.

11. The image processing device according to claim 10, wherein the sensing unit has a plurality of pixels, and the gray-scale image data comprises a plurality of pixel grey level values corresponding to the pixels;
if the pixel grey level value of one of the pixels falls within a threshold range, then the processing unit converts the pixel grey level value of the pixel into a pre-determined grey level value by the processing unit.

12. The image processing device according to claim 10, wherein the total quantities of the original lights is the same.

13. An image processing method, comprising:
obtaining a target color;
projecting a plurality of original lights on an article according to the target color in a retrieving process and controlling the total quantities of the original lights to form a plurality of corresponding optical signals;
sensing the optical signals to generate a plurality of electric signals; and obtaining a target gray-scale image data according to the electric signals.

14. The image processing method according to claim 13, wherein an illuminating ratio exists among the total quantities of the original lights, and the illuminating ratio corresponds to the luminance ratio of the original lights required for forming the target color.

15. The image processing method according to claim 13, wherein the step of projecting the original lights and controlling the total quantities of the original lights comprises:
projecting the original lights by a plurality of original light sources and controlling the projection time of each of the original lights source in the retrieving process, such that an illuminating ratio exists among the total quantities of the original lights, wherein the illuminating ratio corresponds to the luminance ratio of the original lights required for forming the target color.

16. The image processing method according to claim 13, wherein the step of projecting the original lights and the total quantities of the original lights comprises:
projecting the original lights by a plurality of original light sources, and controlling the luminance of each of the original lights source in the retrieving process, such that an illuminating ratio exists among the total quantities of the original lights, wherein the illuminating ratio corresponds to the luminance ratio of the original lights required for forming the target color.

17. The image processing method according to claim 13, an illuminating ratio exists among the total quantities of the original lights, the step of generating the target gray-scale image data further comprises:
generating a plurality of original color gray-scale image data corresponding to the original colors according to the electric signals, and merging the original color gray-scale image data to obtain a target gray-scale image data according to a combination ratio, wherein an overall ratio formed by the combination ratio and the illuminating ratio corresponds to the luminance ratio of the original lights required for forming the target color.

18. The image processing method according to claim 13, the gray-scale image data comprises a plurality of pixel grey level values corresponding to a plurality of pixels, the method further comprises:
converting the pixel grey level value of the pixel into a pre-determined grey level value if the pixel grey level value of one of the pixels falls within a threshold range.

19. The image processing method according to claim 18, wherein the threshold range is the range larger than a threshold grey level value, and the pre-determined grey level value is the maximum grey level value of the target color.

20. The image processing method according to claim 19, further comprising:
setting the threshold grey level value and the pre-determined grey level value.

21. The image processing method according to claim 13, further comprises:
outputting an image according to the target gray-scale image data.
